(19) United States
(12) Patent Application Publication
(10) Pub. No.: US 2021/0364632 A1
(43) Pub. Date: Nov. 25, 2021

(54) Methods and Systems for Map Creation and Calibration of Localization Equipment in an Outdoor Environment

(71) Applicant: Havenshine Technologies, Inc., Naperville, IL (US)

(72) Inventor: Ilya Sagalovich, Naperville, IL (US)

(21) Appl. No.: 17/329,123

(22) Filed: May 24, 2021

Related U.S. Application Data
(60) Provisional application No. 63/029,554, filed on May 24, 2020.

(51) Int. Cl. G01S 13/931; G05D 1/02; G06K 9/00

(52) U.S. Cl. CPC G01S 13/931; G05D 1/0212; G01S 2013/9327; G05D 2201/0201; G05D 2201/0208; G06K 9/00791

(57) ABSTRACT

An autonomous guidance system can include an autonomous vehicle that utilizes both GNSS RTK data and SLAM data to navigate an outdoor environment. In some embodiments, the autonomous vehicle includes a GNSS antenna and at least one SLAM component. In some embodiments, the GNSS antenna is used in connection with a base station and at least one satellite. In some embodiments, the autonomous guidance system interacts with a mobile device associated with an operator.

### CROSS-REFERENCE TO RELATED APPLICATION(S)

This application is related to and claims priority benefits from U.S. Provisional Patent Application No. 63/029,554 filed on May 24, 2020, entitled “Methods and Systems for Map Creation and Calibration of Localization Equipment in an Outdoor Environment”. The '554 application is hereby incorporated by reference herein in its entirety.

### FIELD OF THE INVENTION

The present invention relates to systems and methods for determining the position of and guiding at least partially autonomous vehicles, such as, but not limited to lawnmowers, fertilizers, agricultural tractors, mail delivery robots, snow removal machines, leaf collection machines, security surveillance robots, sports field line painting robots, land surveying equipment, and/or construction machines in outdoor environments. In some embodiments, the systems and methods can be used in boats, self-driving cars, planes, unmanned aerial vehicles, and land surveying equipment.

Traditionally, either one of two technologies have been used to locate and guide autonomous vehicles in outdoor environments: real-time kinematic positioning (RTK) and simultaneous localization and mapping (SLAM).

Real-time kinematic positioning is a satellite navigation technique that enhances the accuracy of data provided by global navigation satellite systems (GNSS) such as GPS, GLONASS, Galileo, NavIC and BeiDou. Typically, the data provided by GNSS is only accurate to roughly a meter. However, RTK allows for accuracy at the centimeter level. The technique involves using a base station with a GNSS receiver located at a known location along with a rover that is free to move with its own GNSS receiver. The base station reduces the error that arises in using GNSS by comparing the difference between signals being received from multiple satellites and transmitting the relevant correction data to the rover. In some embodiments, a single base station can cover an area of up to 60 kilometers.

One problem with real-time kinematic positioning is that this method requires direct sky visibility without obstructions and low-latency connection between base station and rover. As such, real-time kinematic positioning systems often fail under large trees, near buildings, in urban canyons, and anytime there is a network delay which causes increased latency in sending corrections from base station to rover.

Another problem with relying only on real-time kinematic positioning is that even modern GNSS RTK receivers can have a one second or longer latency in position output due to network delays and satellite-signal delays. As a result, it is difficult to use RTK position directly for autonomous navigation in fast-moving vehicles.

The second technology often used to guide autonomous vehicles, simultaneous localization and mapping, involves constructing and/or updating a map of an environment while simultaneously keeping track of the vehicle's location within the environment. Simultaneous localization and mapping can rely on merging and analyzing data obtained from lidars, stereoscopic cameras, infrared depth cameras, inertial measurement units (IMU), ultrasonic sensors, wheel encoders located on the vehicle, and/or other sensors.

SLAM algorithms often use the presence of unique features such buildings and trees in generating their maps. SLAM algorithms can detect these features and then localize against them. The error of a SLAM-based positioning estimate increases as the distance to the mapped features increases. For example, if a camera localizes against an object 50 meters away, the accuracy of localization is significantly worse than if the camera were to localize against an object 2 meters away. Although in many instances, lidars are more accurate than cameras in measuring distance to objects located far away, the distant objects need to have sufficient reflectivity for the laser beam to reflect. In at least some embodiments, the SLAM algorithms are not affected by network delays. In at least some of these embodiments, SLAM algorithms produce fast position outputs assuming proper edge-computing hardware is utilized.

Simultaneous localization and mapping often fails in places with repeated patterns, featureless regions, and reflective surfaces. For example, large fields or lakes often cause problems with simultaneous localization and mapping algorithms as these landscapes lack features to use in the mapping. Furthermore, unobstructed and/or reflected sunlight can blind cameras and/or sensors. In addition, misalignments in the orientation of cameras, IMUs, and/or lidars can lead to position errors caused by false heading estimates. Furthermore, when simultaneous localization and mapping is used to localize against bushes and trees, these features can move in the wind and can grow and change in shape and size over time leading to mapping and localization failures.

What is needed is an autonomous guidance system that combines the benefits of global navigation satellite systems, RTK, and a customized implementation of simultaneous localization and mapping to help map and navigate various areas, such as large fields, with autonomous vehicles such as, but not limited to lawnmowers, fertilizers, agricultural tractors, mail delivery robots, snow removal machines, leaf collection machines, security surveillance robots, sports field line painting robots, and/or construction machines. In some embodiments, older vehicles can be retrofitted to utilize the autonomous guidance system.

### SUMMARY OF THE INVENTION

An autonomous guidance system can include an autonomous vehicle, a base station, at least one satellite, a server, and/or a mobile device. In some embodiments, the autonomous vehicle includes a GNSS antenna and/or at least one SLAM component.

In some embodiments, the autonomous vehicle is one of a lawnmower, an agricultural tractor, or a land-survey device.

In some embodiments, at least one SLAM component is one of a camera, a lidar, an IMU, an ultrasonic sensor, a downward facing sensor, a physical touch sensor, a wheel encoder, or commands/signals applied to vehicle's actuators.

In some embodiments, data from at least one SLAM component is compared with RTK calculated data.

In some embodiments, the GNSS antenna is used to generate a map.

In some embodiments, the map is shared with a second autonomous vehicle.

In some embodiments, the GNSS antenna is used to calibrate a model.

In some embodiments, the model is shared with a second autonomous vehicle.

In some embodiments, the autonomous guidance system can be utilized to retrofit an older vehicle and make it autonomous.

### BRIEF DESCRIPTION OF THE DRAWINGS

FIG. 1 is a schematic of an autonomous vehicle utilizing various positioning technologies to navigate an outdoor environment.

FIG. 2 is a schematic of data analyzed in some embodiments of an autonomous guidance system when a reliable GNSS RTK signal is present.

FIG. 3 is a schematic of data analyzed in some embodiments of an autonomous guidance system when a GNSS RTK signal is weak or absent.

FIG. 4 is a front view of an autonomous lawnmower mowing grass.

FIG. 5 is a front view of an autonomous vehicle moving along an incline.

FIG. 6 is an example of using parallel path planning inside a polygon.

FIG. 7A is a photograph taken with an infrared sensor.

FIG. 7B is a photograph of the same image of FIG. 7A taken using a traditional camera.

FIG. 7C is a graph of the point cloud data derived from analyzing FIG. 7A.

### DETAILED DESCRIPTION OF ILLUSTRATIVE EMBODIMENT(S)

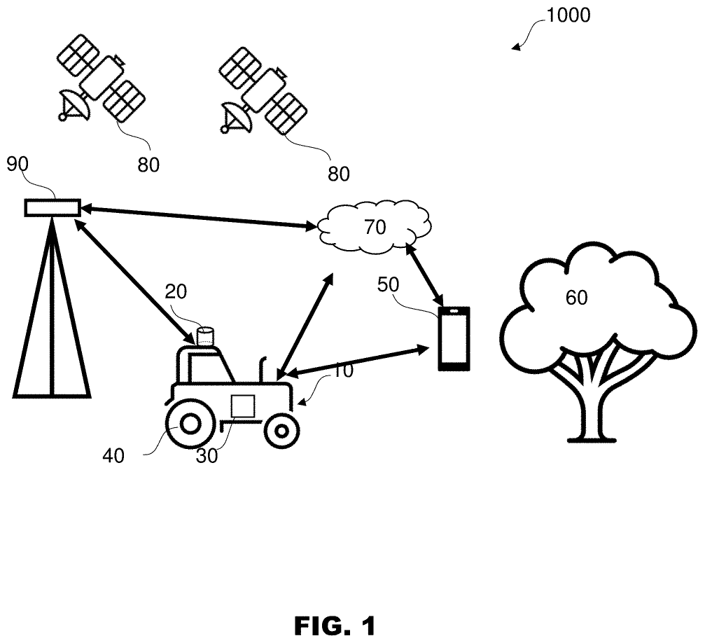

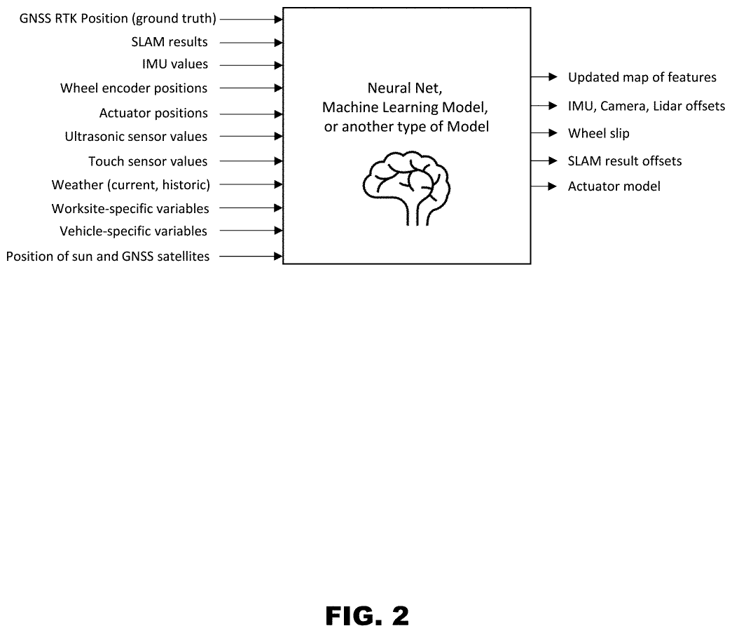

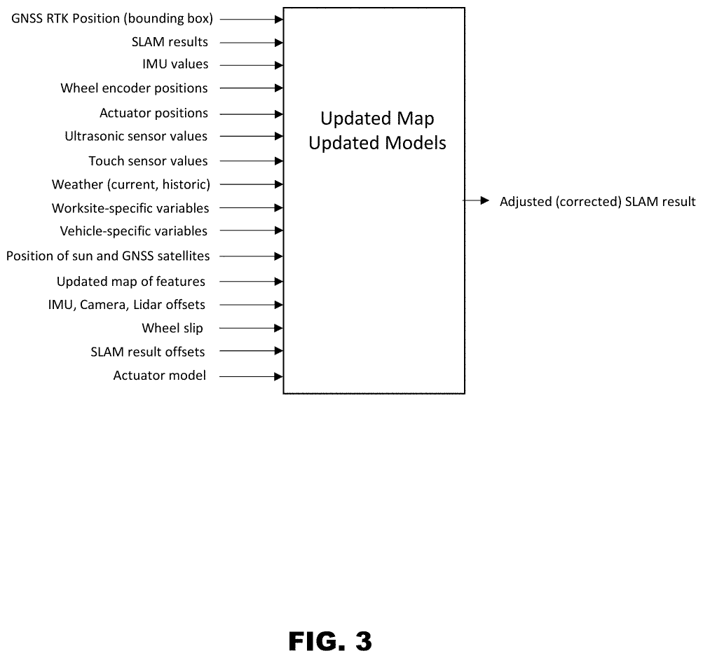

FIG. 1 illustrates autonomous guidance system 1000. In some embodiments, autonomous guidance system 1000 includes autonomous vehicle 10 utilizing both a global navigation satellite system and/or simultaneous localization and mapping to help map and navigate various areas. In some embodiments, autonomous guidance system 1000 utilizes real-time kinematic positioning.

In some embodiments, autonomous vehicle 10 is a lawnmower, fertilizer, agricultural tractor, mail delivery robot, snow removal machine, leaf collection machine, security surveillance robot, sports field line painting robot, drone, land-survey device, and/or construction machine. In some embodiments, autonomous guidance system 1000 can be utilized to retrofit an older non-autonomous vehicle and make it autonomous.

In at least some embodiments, autonomous vehicle 10 includes GNSS antenna 20. In some embodiments, GNSS antenna 20 is a RTK GNSS antenna. In some embodiments, GNSS antenna 20 communicates with at least one satellite 80. In some embodiments, GNSS antenna 20 communicates with multiple satellites 80.

In some embodiments, RTK base station 90 is used. In some embodiments, RTK base station 90 communicates with at least one satellite 80. In some embodiments, RTK base station 90 communicates with multiple satellites 80.

In at least some embodiments, autonomous vehicle 10 includes at least one SLAM component 30. In at least some embodiments, SLAM component 30 collects data that can be used to build a map of the surrounding area and/or navigate autonomous vehicle 10 through the same. In some embodiments, SLAM component 30 can be, among other things, a camera, a lidar, an IMU, a downward facing sensor to detect height and/or texture differences and/or an ultrasonic sensor. In some embodiments, SLAM component 30 is an impact sensing bumper. In some embodiments, SLAM component 30 is an encoder installed on the wheel of a vehicle. In some embodiments, SLAM component 30 is a signal/command applied to the actuators of autonomous vehicle 10.

In FIG. 1 feature 60 (shown as a tree) can be used by the simultaneous localization and mapping system in generating a map and navigating autonomous vehicle 10. In some embodiments, feature 60 can obstruct the signal coming from satellite 80. In some embodiments, feature 60 can change over time.

In at least some embodiments, autonomous vehicle 10 includes at least one wheel encoder 40. In some embodiments, wheel encoder 40 measures the angular position of the wheel. In some embodiments, autonomous vehicle 10 includes multiple wheel encoders 40. In some embodiments, autonomous guidance system 1000 compares data from multiple wheel encoders 40.

In at least some embodiments, data from at least one SLAM component 30, at least one wheel encoder 40, GNSS antenna 20, autonomous vehicle 10, base station 90, and/or satellite 80 can be transmitted to server 70 to be analyzed and/or manipulated. In some embodiments, server 70 is located on site. In some embodiments, server 70 is in the cloud. In some embodiments this data is used to calculate various factors such as, but not limited to, IMU calibration, errors, and/or misalignment, camera calibration errors, camera misalignments, and/or lidar misalignments.

In some embodiments, autonomous vehicle 10 captures at least one of the following parameters and uploads them to server 70: RTK position estimate (result and quality of estimate); SLAM position estimate (result and quality of estimate); images captured by SLAM cameras and/or lidars; raw IMU values such as those coming from an accelerometer, gyroscope, and/or magnetometer; raw wheel encoder values (exact wheel position); raw ultrasonic sensor values; raw values captured by downward facing sensors; impact sensing bumper; and/or steering actuator values and motion actuator values.

In some embodiments, RTK data, such as a RTK calculated position is used to calibrate SLAM components such as, but not limited to, lidars, stereoscopic cameras, infrared depth cameras, IMUs, ultrasonic sensors, and/or wheel encoders. In some embodiments, this resulting calibration can be used to adjust the SLAM-based position estimate when GNSS signals are not available. In some embodiments, once the model is created and calibrated, it can be used with vehicles that do not have RTK receivers and/or SLAM components.

In some embodiments, when the autonomous guidance system 1000 is receiving consistent and reliable GNSS signals and there are unique features that can be seen by at least one SLAM component, a strong RTK position estimate (RTK fix) and a strong SLAM position estimate can be determined. This often occurs when the unique features are easily detected by SLAM components, but these features do not block the sky. Examples of such features include, but are not limited to, mailboxes, power boxes, chairs, other vehicles, and small bushes. These features allow SLAM algorithm(s) to give a position result with a level of confidence. At the same time, since the sky view is clear, GNSS RTK can provide reliable data. In at least some embodiments, the algorithm(s) can take the GNSS RTK result to be the ground truth and use it to compute the “error” in the SLAM position estimates. In some embodiments, this “error” can then be used in the exact same location when GNSS RTK signal is temporarily unavailable due to a temporary problem such as network delays.

In some embodiments, even when the RTK signal is strong (RTK fix), the system can utilize SLAM components, such as IMU and wheel encoders, to give intermediate positions. In some embodiments, this is done because of the large latency in the position computed based on GNSS-RTK. So, for example, in some embodiments, if the vehicle hits a bump and this bump causes the path to change, then the IMU and wheel encoders can sense the change in path about 1 second earlier than the RTK receiver. This means that the closed-loop control system can start responding 1 second quicker and keep the vehicle on a straight, or at least straighter line.

SLAM position estimates can be incorrect due to numerous factors such as, but not limited to, changing features (e.g., growing bushes and trees) and/or camera-specific limitations, such as lens geometry.

In at least some embodiments, wheel encoders 40 are not sufficient to accurately calculate the position of autonomous vehicle 10. In at least some embodiments, this can be due to, among other things, wheel slip. Wheel slip can be a function of multiple variables, including, but not limited to, the size, age, and/or material of the wheel, the weight of autonomous vehicle 10, how wet the surface is (based on direct measurements and/or on historical weather patterns such as recent rainfall), the type of surface (such as asphalt, grass, dirt, etc.), and/or the incline of the surface.

In some embodiments, autonomous guidance system 1000 records the values applied to the actuators as the vehicle moves from one point to another. In at least some embodiments, during an initial run over a new area, autonomous guidance system 1000 relies on a closed-loop control system to produce the actuation values. On a future run the autonomous guidance system 1000 uses the calculated values as “feed-forward” control values to decrease the error of the vehicle. In some embodiments, the autonomous guidance system 1000 calculates new actuation values which can act as “feed-forward” control values for future runs. Overtime, these “feed-forward” control values improve efficiency and/or performance of the vehicle.

In the above example, there can be many factors which contribute to the need for “feed-forward” control values to improve performance, including, but not limited to, that the vehicle may be operating on a slope, the vehicle may be hitting a hole some sort of bump along the path, and/or a given motor is getting old and requires more power to operate.

In at least some embodiments, slopes, holes, and bumps can be identified with an IMU. In at least some embodiments, IMUs contain inclinometers which can sense the tilt of the vehicle with respect to the horizon. In some embodiments, autonomous guidance system 1000 can use this tilt to perform corrections before the error can accumulate. In some embodiments, to determine how much correction is needed, a model which correlates mower tilt with the power required for the actuators to keep the mower moving straight can be calculated and the utilized in future runs.

Environmental factors, such as, but not limited to, grass height, weather, precipitation, and wind can be considered when building the model. In some embodiments, multiple models can be built for a given area and utilized based on the given conditions of a particular run. In some embodiments, the current environmental conditions can be determined via SLAM sensors, a humidity sensor, or utilizing data generated from an independent source, such as weather data provided from a third party. In some embodiments, the height of grass can be determined using sensors installed on the vehicle, such as an IR camera.

In some embodiments, autonomous guidance system 1000 can use the calculated models when a RTK signal is not present or is poor (due to obstructions or network delays/outages). In some such embodiments, the autonomous guidance system 1000 can also use data from a magnetometer, an accelerometer, the positions of wheel encoders, and/or patterns detected on the ground to determine the heading and position of the vehicle. In some embodiments, a 3D lidar can be used to approximate the position.

In at least some embodiments, IMUs alone are not sufficient to accurately estimate the position of autonomous vehicle 10. In some embodiments, the position reported by an IMU drifts over time due to the accumulation of inertial errors.

Similarly, in at least some embodiments, lidars and/or cameras are susceptible to errors resulting from, among other things, accuracy limitations of equipment, localizing against features too far away, localizing against features which change overtime, camera, lidar, and/or IMU misalignments, and/or sunlight blinding the sensors. Furthermore, when localizing against changing landscapes, such as bushes or trees, cameras and lidars can have a slow drift in the computed position.

In some embodiments, by collecting data related to parameters which affect wheel slip, IMU measurements, and other SLAM components, autonomous guidance system 1000 can generate a model that predicts how large the various component errors are and the direction of these errors. This model can then be compared and adjusted with data coming from the GNSS signals.

In at least some embodiments, the GNSS RTK derived computed error can be used to adjust the map used in SLAM localization. In some embodiments, the computed error can be used in a model which can estimate the camera-lens inaccuracies. In at least some embodiments, once a model is built and calibrated, it can be used to accurately compute positions of a vehicle in places where GNSS signals are not available and/or temporarily absent. The error estimates computed by the model can be applied to the values generated by SLAM components (wheel encoders, IMUs, cameras, and lidars) to compute an accurate position which accounts for the errors.

In some embodiments, the computed error, and its direction, can be used to detect if one of the SLAM components, such as a camera or IMU, is unaligned with vehicle's direction. In at least some embodiments, this allows for computing of an offset which is later used in position determination.

In some embodiments, when autonomous vehicle 10 moves to an area where the GNSS signal is weak, for example near a large tree or close to a building, it can detect some of the same features, such as power boxes and bushes. But the autonomous guidance system 1000 now knows the “correct” locations of these objects via the GNSS RTK derived map. In some embodiments, autonomous guidance system 1000 can create a model which considers camera-lens inaccuracies and camera/IMU misalignments. In some embodiments, the updated map, in combination with the “error models” for the SLAM components, can be used to give an improved SLAM position estimate in the areas where the RTK signal is weak and/or temporarily absent.

In some embodiments, RTK can be used to compute the heading of the vehicle. In at least some embodiments, the measured heading is in degrees from true north. In at least some embodiments, it is beneficial for several reasons including the fact that Earth's magnetic pole is about 1000 miles south of the true north pole and is continuously shifting and, as such, magnetic north is not true north. In addition, in at least some instances, magnetic compasses are susceptible to electromagnetic interference from nearby components such as, but not limited to, electrical motors.

In some embodiments, data from a magnetometer, which is often found in many IMUs is not accurate (for the reasons discussed above). However, this data comes at a faster speed than RTK data. As a result, in some embodiments, autonomous guidance system 1000 can use the magnetometer data to get intermediate heading estimates. In some embodiments, the autonomous guidance system 1000 can determine the error in the magnetometer data by comparing it to the GNSS RTK data. The calculated error can be used to recalibrate the magnetometer data. In some embodiments, the autonomous guidance system 1000 can determine the error for different parts of a map. These errors can then be taken into account depending on where the vehicle is located. In some embodiments, the error calculation can be used during outages of GNSS RTK to get approximate heading estimates. In some embodiments, it can be used to get faster heading readings while waiting for GNSS RTK data.

In one method for determining a heading, a GNSS RTK receiver is installed at the front of a vehicle. As the vehicle performs a zero-degree turn, the GNSS RTK receiver moves along the circumference of a circle. By rotating the vehicle by a given angle, it is possible to capture positions along the circumference of the circle. These positions can then be used to compute an equation for the circle and find the center of the circle. The heading of the vehicle can then be computed as the heading from the center of the circle to the current position of the GNSS RTK receiver. This computed heading is significantly more accurate than the heading obtained with a magnetic compass.

A second method for determining a heading involves moving the vehicle straight for a given distance (for example several centimeters) on a flat surface. By comparing the GNSS RTK positions of the vehicle before the move and after the move, the computer on the vehicle can determine its heading.

Once the heading is known, it can be updated during consecutive turns and during linear travel. In at least some embodiments, the heading can also be used to navigate a geospatial path.

In at least some embodiments, having both position and heading results from both GNSS and simultaneous localization and mapping, allows autonomous guidance system 1000 to calculate a coordinate system transform for both frames of reference. In other words, both real-time kinematic positioning and simultaneous localization and mapping solutions can be transformed to provide position and heading measurements with respect to a predetermined frame of reference.

Once both solutions are transformed to the same frame of reference, RTK data can be used to calibrate the SLAM components. For example, if SLAM cameras, IMUs, and/or lidars are misaligned and are pointing in the wrong direction, RTK data can be used to detect this misalignment and compute the degree by which the components are misaligned. This information can then be used in the calculation of the coordinate transform to “virtually re-align” the SLAM components.

In some embodiments, when performing SLAM computations, the actuation values of autonomous vehicle 10 such as its steering angle and power applied to its actuators (voltage and current), can be considered.

In some embodiments the SLAM computation can use the GNSS RTK signal even when the signal is weak. In at least some of these cases, the GNSS RTK signal is not used as the ground truth but instead used to confine/restrict the SLAM result to a given area, such as a 5-meter circle. By confining the SLAM result, the localization process can be quickened.

In some embodiments, simultaneous localization and mapping can localize using a feature, such as a bush, that changes with time. In some of these embodiments, the SLAM components give false position estimates due to the changing feature. By transforming RTK and SLAM solutions into the same frame of reference, it is possible to compute how the features change overtime and adjust the SLAM position estimates.

In some embodiments, the rate at which the feature, such as a tree, bush, and/or crop grows is a useful metric which can be uploaded to server 70 in autonomous guidance system 1000 and used in other applications.

In some embodiments, autonomous guidance system 1000 is configured to be utilized when certain features change throughout the year. For example, in some embodiments, autonomous guidance system 1000 is configured to compensate for when deciduous trees drop their leaves.

In some embodiments, autonomous guidance system 1000 can be run when leaves are not on the trees. In some embodiments, this allows autonomous guidance system 1000 to receive more accurate and reliable information from satellites 80. In some embodiments, a user could initially map an area when leaves are not on the trees. In some embodiments, this allows autonomous guidance system 1000 to generate a calibration for the model even in places where a GNSS signal is normally too weak to obtain a good position estimate and/or a good estimate for the positions of surrounding objects. In at least some of these embodiments, once the leaves on the trees re-appear, the calibrated model can be used to compute accurate positions which account for errors of the SLAM components and use the pre-estimated positions of surrounding objects.

In some embodiments, combining GNSS with SLAM components provides greater cyber security of system 1000. For example, hackers have been known to hijack GNSS RTK signals and then send false satellite positions and confuse the GNSS receiver into obtaining incorrect position estimates. A system 1000 utilizing SLAM components in conjunction with GNSS signals is more likely to detect that the signal has been hijacked as the system could compare the GNSS calculated position with the position estimated by the SLAM components.

Optimizing Operating Time and/or Paths for Each Worksite

In at least some embodiments, autonomous guidance system 1000 can be configured to a given worksite. For example, the sun's position in the sky is well known and can be accurately predicted for each day of the year. Given that the sun blinds some SLAM components, in some embodiments, it is possible to operate the system in ways that avoids, at least in part, direct sunlight and the resulting incorrect position estimates. Similarly, the positions of GNSS satellites are well known and can be accurately predicted. In some embodiments, autonomous guidance system 1000 uses this to ensure that the maximum number of satellites, or at least many GNSS satellites are visible for a specific time of day, at the specific work site.

Similarly, known weather conditions, such as rainfall, wind, hail, temperature, and snow, can be used to predict dangerous and unreliable operating conditions at a given worksite.

In at least some embodiments, path-plans for worksites can be pre-planned by generating a polygon around the perimeter of the worksite and then planning the path inside the polygon using parallel linear equations. See for example FIG. 6.

In at least some embodiments, the input to the polygon-generating-algorithm is a collection of (X,Y) points which define the boundary of a worksite. In at least some embodiments, the points are measured with respect to some reference geospatial position located at (0,0). In FIG. 6, five points define the boundary of the worksite (although various numbers of points can be used).

In some embodiments, it is possible to combine polygon-path-plans with custom path plans created by recording the motion of a manually driven vehicle.

Boundary points can be determined in several ways. In some embodiments, the boundary points are determined by manually driving the vehicle around the worksite (either via directly controlling the vehicle or via remote control). In some such embodiments, the boundary points are automatically generated by adding a “line of best fit” where the errors are below a given amount, for example, 0.5 meters. In some such embodiments, sharp changes in heading signify the vertices of boundary.

In other or the same embodiments, boundary points can be marked manually by an operator (for example via a mobile application). In some embodiments, this can be done while the operator is driving the vehicle around a perimeter of the worksite.

In some embodiments, the boundary of the worksite can be specified on a virtual map. In some embodiments, this can be done remotely.

In some embodiments, once the boundary points are known autonomous guidance system 1000 can plan a path that is parallel to one of the sides of the boundary such as shown in FIG. 6. In some embodiments, when planning a path for a vehicle, such as lawnmower, autonomous guidance system 1000 takes into account the width of the vehicle to allow sufficient overlap and to ensure, or at least increase the chances, that the entire area is covered.

In some embodiments, several polygons can be combined to create complex worksites. In some embodiments, when known objects/obstacles are located inside the worksite, their positions can be defined so that the autonomous vehicle can safely navigate around them. In some embodiments, defining the precise positions of objects involves driving the vehicle, sometimes manually, near the objects and performing sensor fusion of data to combine the vehicle's position (GNSS RTK) with the point-cloud detected by Lidars/Cameras. In some embodiments, once the locations of these objects are known, path plans can be generated to safely navigate around the objects.

In some embodiments, a complete path plan, which includes position setpoints and locations of various objects, can be generated through a manual operation of the vehicle at the worksite. For example, when the autonomous vehicle is a lawnmower, an operator can perform full manual mowing and this process will capture the position setpoints (GNSS RTK), the locations of the various objects, and the way in which the autonomous vehicle should navigate around the objects.

In some embodiments, the operator can manually navigate just around the obstacles, instead of the whole path, to “teach” the vehicle how the obstacles should be avoided. In some embodiments, the data can then be combined with a polygon path-plan to generate a complete map for the worksite.

In some embodiments, several different path plans can be generated for a given worksite (ex. east to west, south to north, and diagonal). In some embodiments, when a vehicle is powered near a worksite, it can automatically recognize which worksite it is on by comparing its geolocation to the geolocations of the pre-planned worksites. In some embodiments, this involves using an algorithm. In some embodiment the algorithm pulls a list of possible maps by comparing the recorded locations of pre-planned maps with the actual location of the vehicle until a map(s) is/are found in which the vehicle is within a first given distance (e.g., 1 km) of the starting point on the map. These maps can then be further filtered to the correct map by determining a map in which the vehicle is a within a second given distance (e.g. 10 m) of any point on the map.

In some embodiments, the vehicle can pick a path plan based on various factors, such as which path plan was executed in previous runs, past weather data, current weather data, and/or predicted weather data. For example, in some embodiments the vehicle can automatically cycle through the different path plans (east to west, south to north, and diagonal). In some embodiments the vehicle can may choose a particular path in light of predicted conditions caused by the weather (either current or past).

### Downward Facing Position Determination

Humans often rely on downward facing position estimates (e.g. straight lines) when performing tasks such as lawnmowing and plowing of fields. In at least some embodiments, autonomous guidance system 1000 can use downward sensors to detect the straight lines on the field and use it to guide a machine in parallel straight lines. In at least some of these embodiments, this allows for a more traditional looking result. For example, grass can be mowed in straight lines, verse the randomized paths taken by some current autonomous lawnmowers.

In some embodiments, the downward sensors are infrared cameras. In some embodiments, the downward sensors are infrared depth cameras. In some embodiments, these cameras perform image analysis to detect lines.

In some embodiments, the downward sensors are ultrasonic sensors that detect a difference in height.

In some embodiments, the downward sensors are stick-sensors to measure friction of surfaces at different locations. In some embodiments, these sensors are made from adjacent flexible sticks which contact the ground, or the elements above the ground such as, but not limited to, grass or crops. In at least some embodiments, the friction measured by the sticks is related to the height of the materials they touch. In at least some embodiments, it is possible to estimate the height on the different surfaces and use that data in autonomous guidance system 1000 to maintain a constant overlap between the adjacent lines.

In some embodiments, the autonomous vehicle can output/produce certain markers which can be detected by its systems. For example, markers can be seeds of unique color, fertilizer, or even water. These markers can be detected on an adjacent parallel run to help estimate the location of the autonomous vehicle.

In some embodiments, the initial straight line can be generated at a place where a GNSS signal is present. In some embodiments, the initial straight line can be generated by a human manually driving the machine. In some embodiments, the initial straight line can be generated based on features parallel to the field such as a sidewalk, road, fence, etc. In some embodiments, the nature of these parallel features can come from data originating from a third party.

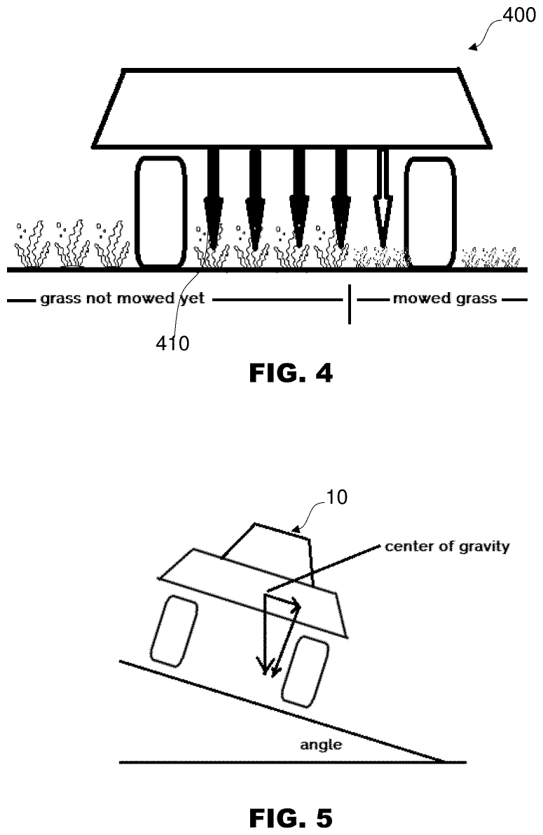

FIG. 4 illustrates a front view of autonomous lawnmower 400 mowing grass. In some embodiments, flexible bendable sticks 410 make contact with the grass to determine the length of the grass, both mowed and unmowed. In some embodiments, downward-pointing ultrasonic sensors can be used to determine the length of the grass, both mowed and unmowed. In some embodiments, overlap between mowed and unmowed grass can be used as an input to autonomous guidance system 1000. In some embodiments, where a GNSS signal is present, the detected overlap height can be used to calibrate a model that can then be used in places where GNSS signals are absent.

In some embodiments, the downward facing sensor can be used to detect a worksite perimeter/boundary. For example, in some embodiments, the perimeter can be mowed manually by an operator. In some of these embodiments, the downward facing sensor can be used to detect the boundary by detecting the height difference.

In some embodiments, such as when autonomous guidance system 1000 is used in lawn care or agriculture fields, the height of grass and/or crops can be used to compute the rate at which the grass and/or crops are growing. This rate, in combination with weather data (rainfall, temperature, etc.), can be used to predict the expected height of the grass/crop and adjust frequency of mowing/harvesting cycles. Additionally, in some embodiments, the data detected by cameras can be used to analyze the health of the lawn and/or crops. In some applications, the autonomous vehicle can automatically disperse water, fertilizer, or seeds only in places which require treatment (based on analysis of the ground).

Determining When to Stop a Vehicle and/or Avoid an Unexpected Objects

In at least some embodiments, unexpected objects can present themselves at a given worksite. For example, in some embodiments, the unexpected object can be a ball, a large stick, a rock, a piece of trash, or an injured animal. In some instances, not avoiding these objects can damage the autonomous vehicle, such as ruining the blade of a lawnmower. In at least some embodiments, autonomous guidance system 1000 can be configured to detect these items and either stop before running into them and/or adjust its course to avoid them.

In some embodiments, autonomous guidance system 1000 can return the vehicle to the area of the unexpected object at a later time to determine if it is now safe to mow, fertilize, plow, etc. In at least some embodiments, autonomous guidance system 1000 sends an alert to a user to check the location in which the unexpected object was present.

In at least some embodiments, autonomous guidance system 1000 utilizes data from a pre-generated map to determine if the object is unexpected. In some embodiments, data from a pre-generated map, for example the presence of nearby trees, can be used to predict the likelihood that the unexpected object is a leaf.

In at least some embodiments, the size of the unexpected object plays a role in determining whether the autonomous vehicle should stop and/or avoid the unexpected object. In at least some embodiments, any object larger than a couple of inches in width and/or height can trigger autonomous vehicle to stop and/or avoid it. In some embodiments, unexpected objects that move can be avoided. For example, in some embodiments the system can distinguish between unexpected objects that do not need to be avoided (such as leaves blowing in the wind and objects that should be avoided such as animals. In some embodiments, this is accomplished via AI analyzing the motion captured by cameras and/or Lidars. In some embodiments, the system uses an infrared camera to predict whether an object is alive.

In at least some embodiments, unexpected objects can be detected, and their sizes can be computed, through analysis of vertical and horizontal jumps in the point cloud data.

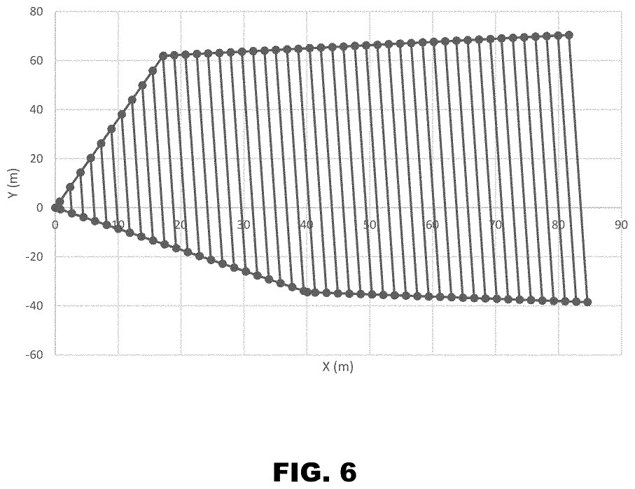

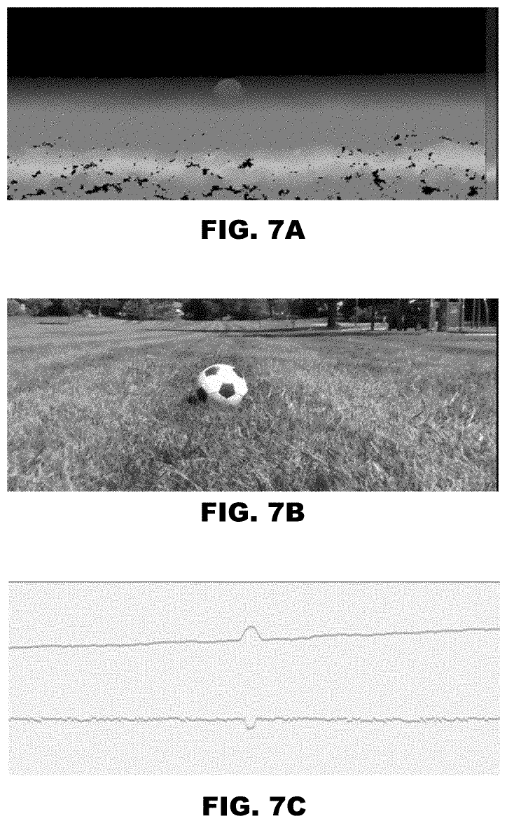

In some embodiments, data from an infrared sensor can be compared with data from a RGB image originating from a camera. See for example FIG. 7A and FIG. 7B. In some embodiments, this data can be used to conduct a vertical analysis of the point cloud data such as shown in FIG. 7C. In some embodiments, the autonomous guidance system 1000 can be configured to detect spikes in the data and identify them as unexpected objects. In some embodiments, autonomous guidance system 1000 ignores spikes less than a given percentage. In some embodiments, these smaller spikes can correspond to a large leaf, a pile of leaves, and/or tall grass.

In some embodiments, the below analysis can be performed with point cloud data originating from an IR depth camera or from a Lidar. In some embodiments, the system loops through each row in the depth data from left to right (or from right to left). For each row, the system loops through each column in the depth data from top to bottom (or bottom to top).

The system then determines the depth in current pixel (distance from camera to the pixel) and compares it to the depth of the previous pixel. In this example, the previous pixel is the pixel immediately to the left of the current pixel. If there is a significant difference between the depth of the current pixel and the depth of the previous pixel, then the system determines there is a possible unexpected object in this location. In some embodiments, the threshold difference is at least 0.25 m. In some embodiments, the threshold difference is at least 0.2 m.

By way of example, for a camera mounted to a lawnmower about a foot off the ground and pointing straight, it is normal to see depth jumps of 0.2 m or lower. These are typical depth jumps between adjacent individual grass pieces. In some cases, especially when dealing with tall grass, this threshold can be as high as 1.0 m. In some embodiments, the threshold used can be dynamically determined by running the mower for a short distance on a section of the field where the grass is tall. In some embodiments, this can be done automatically at each start. In some embodiments, to decide on whether an object is truly present in the frame, the size of the object can be computed using its boundary (the rows and columns where the object started and ended) and using information about the camera's lens geometry. For example, if the height of the object exceeds a given height and/or width (e.g., 2 inches), then it is likely to be a real object. In some embodiments, the system treats possible objects that fall under a given threshold as noise.

In some embodiments where RGB data from camera is present, its pixel values can be correlated to the depth data at the location of the object to check whether the objects color is significantly different from the area surrounding it, such as grass. This can add another level of certainty to whether an object is present and can be considered by the autonomous guidance system 1000.

In some embodiments, autonomous guidance system 1000 can run the RGB image of the object through an AI model to determine whether this object is likely to be something like a leaf, which can be safely ignored, or whether it is something like a rock which can damage the blade.

The analysis described above is a horizontal pixel analysis. Similar analyses can be performed vertically by comparing the current pixel value to the one right above it and computing vertical jumps in the distance.

The results from both the horizontal and vertical analyses help create a more reliable conclusion on the presence of unexpected objects and their dimensions.

In some embodiments, data from a camera can be used by autonomous guidance system 1000 to identify the unexpected object. In some embodiments, this identification is accomplished by comparing the image of the unexpected object with a database of preidentified objects, such as balls, leaves, sticks, rocks, and the like.

In some embodiments, data regarding the unexpected object can be sent to an operator. In some embodiments, the operator can be on site. In some embodiments, the data is accessed via a mobile device such as a smart phone, computer, tablet, or the like. In some embodiments, the information is sent via a wireless signal. In some embodiments, the autonomous vehicle can transmit signals via one of several wireless communications protocols, such as Bluetooth, Wi-Fi, CDMA, 900 MHz, 3G/4G/5G/Cellular, near-field communication, and/or other communication protocol to a network and/or directly to a mobile device.

In some embodiments, when an unexpected object is detected, the autonomous vehicle comes to a stop and the operator can be alerted. In some embodiments, the operator is shown an image of the unexpected object on a mobile device. In some embodiments, the operator then has a choice: either go to the vehicle and remove the unexpected object or click a button on the mobile device to ignore the object and allow the vehicle to continue to move forward and/or move around the object. For example, when the unexpected object is a leaf or some tall weeds, the operator can choose to ignore the unexpected object and allow the vehicle to continue forward. In some embodiments, the operator's decision, along with an image of the unexpected object, are then saved on a remote server. In some embodiments, the data in the server is then periodically analyzed to generate a machine-learning model (ML) which determines which unexpected objects should require the vehicle to stop and which objects can be ignored. In at least some embodiments, autonomous guidance system 1000 can also utilize data from a pre-generated map to determine if the object is unexpected. In some embodiments, data from a pre-generated map, for example the presence of nearby trees, can be used to predict the likelihood the unexpected object is a leaf. In at least some embodiments, the ML model correctly recognizes small objects, such as leaves and weeds, which should be ignored by the autonomous vehicle.

### Altitude-Based Path Planning

In the landscaping and construction industries, some of the most challenging work sites contain steep slopes. In some embodiments, it can be desirable to operate a vehicle along the incline (at a constant altitude). However, it is not always clear whether such an operation is safe. When operating along a steep incline, vehicles such as lawnmowers are susceptible to flipping over, which can cause serious injuries.

In some embodiments, autonomous guidance system 1000 can be used to map out safe paths for vehicles, such as autonomous vehicle 10 to follow. To determine whether autonomous vehicle 10 will flip over, an algorithm can compute the center of gravity for autonomous vehicle 10 and determine at what angle of incline autonomous vehicle 10 would flip. FIG. 5 illustrates this principle.

In some embodiments, safety margins can be added to account for various factors, such as but not limited to, unexpected bumps, rocks, and wind.

In some embodiments, when operation along the incline is deemed to be unsafe, path planning can be implemented to navigate autonomous vehicle 10 up and down the incline instead of across it.

In some embodiments, climbing up the incline may not be possible due various factors such as of low traction and/or the slope being too steep. In some embodiments, this low traction may result from the surface being wet. In some cases, it is possible for the vehicle to climb up the incline, but it is undesired as it can damage the lawn and/or the vehicle. In at least some of these instances, autonomous guidance system 1000 can guide autonomous vehicle 10 to go down the incline and climb back up via a less steep path.

In some embodiments, path planning can be fully automated with the help of topographical data of the worksite which, in some embodiments, can be gathered with the help of GNSS RTK and SLAM components and/or originate from, or at least be supplemented with information from a third party.

### Using a Transform to Improve GNSS RTK Position Estimates

In some embodiments, autonomous guidance system 1000 can return take into account the fact that data arriving from certain SLAM components can be compromised due to the position of the SLAM component.

For example, when operating on an incline, or when encountering a hole in the ground, the RTK position estimate does not reflect the true position of the vehicle (the center between the vehicle wheels). In embodiments where the RTK antenna is located at the top of the vehicle, the difference can be magnified. The issue can be partially mitigated by placing the antenna closer to the ground. However, in some embodiments, this may not be possible and/or recommended because it would then introduce noise (obstructions and ground noise) for the GNSS RTK signal.

In some embodiments, autonomous guidance system 1000 determined the tilt of the vehicle, such as from an IMU and uses the tilt angle to compute the offset between the RTK position and the real position of the vehicle. In some embodiments, the system takes into account the time difference between the tilt data arriving from the IMU and the GNSS RTK data.

Uses of Mobile Devices with Autonomous Guidance Systems

As mentioned above, various devices such as mobile devices, including, but not limited to, smartphones, tablets, laptops, and the like, can be used with autonomous guidance system 1000. In some embodiments, mobile device 50 is designed specifically to work with autonomous guidance system 1000. In some embodiments, mobile device 50 is a traditional mobile device, such as a smartphone or tablet, that can be retrofitted, either via software such as downloadable application and/or additional pieces of hardware, to work with autonomous guidance system 1000.

In some embodiments, a mobile device can be used as an emergency stop switch “E-switch”. In some embodiments, an operator can shut down one or more autonomous vehicles via said “E-switch”. In some embodiments, the operator is on site. In some embodiments, the operator is at a remote location.

In some embodiments, the E-switch utilizes a long-range radio as a way of sending a stop signal from transmitter to receiver.

In some preferred embodiments, autonomous guidance system 1000 uses an internet-connected mobile device as a way of communicating with the autonomous vehicle, such as commanding an emergency stop.

In some embodiments, an application running on a mobile device can regularly send “run” commands to a server and monitor for physical button presses. In some embodiments, if a button is pressed on the mobile device, such as home button, volume up, or volume down, the application can send a “stop” command to a server and then will stop transmitting messages. In some embodiments, by running as a foreground service, the application can continue to work even when the screen is turned off and the mobile device is put away, such as in an operator's pocket.

In some embodiments, a wireless communications protocol, such as Bluetooth, Wi-Fi, CDMA, 900 MHz, 3G/4G/5G/Cellular, near-field communication, and/or other communication protocol is used to send a stop signal from a stop switch to the mobile device. In some embodiments, this allows the switch to be in an easily accessible location such as on the belt or on the hand of the operator. In some embodiments, there is a hard-wired digital interface between the switch and the phone. In some embodiments, this allows the switch to send commands over the digital interface. In some embodiments, the switch can contain at least one button. In some embodiments, the switch can contain at least two buttons. In some embodiments, a first button can be used to pause operation of one or more autonomous vehicles and a second button can be used to completely stop operation of one or more autonomous vehicles.

In some embodiments, the switch can interrupt the power coming from a portable battery. In some embodiments, the application monitors whether the mobile device is connected to the battery. In some embodiments, when the mobile device is disconnected from the battery, a stop command is sent to the vehicle. In at least some embodiments, an external portable battery is useful to prevent the mobile device from discharging and shutting off in the middle of an autonomous run. In at least some embodiments, the above setup allows for compatibility across different mobile devices. In some embodiments, the switch can be located on the battery itself. In some embodiments, the battery can be plugged directly into the mobile device. In some embodiments, a cable is used to connect the battery to the mobile device. In some embodiments, the switch includes an indicator to show its state (ON/OFF). In some embodiments, the indicator is an LED. In some embodiments, the indicator is a plurality of LEDs.

In some embodiments, the switch is a physical button. In some embodiments, the switch can be a magnetically coupled connector which can be disconnected by pulling on the cable.

In some embodiments, mobile devices can be used with autonomous guidance system 1000 to geofence in one or more autonomous vehicles. In some embodiments, by comparing the GPS geolocation of the mobile device with the geolocation of the vehicle, it is possible to know how far away the mobile device is from the vehicle. In some embodiments, this allows autonomous guidance system 1000, often through an application, to set a precise distance from the mobile device at which point the vehicle should stop.

In some embodiments, this allows autonomous guidance system 1000 to compare the location of a mobile device to the location of the pre-planned worksite. In some embodiments, when the mobile device gets a predetermined distance from a worksite, one or more autonomous vehicles will automatically come to a stop. In some embodiments, the feature prevents, or at least reduces the chance that vehicles will continue operating autonomously when the operator leaves the worksite. This can be beneficial if the operator unexpectedly and/or suddenly leaves the worksite.

In some embodiments, the autonomous guidance system 1000 can be configured such that if the geolocation of the operator (as determined via the mobile device) is too close the geolocation of the autonomous vehicle, the vehicle can automatically come to a stop to prevent an accidental collision with the operator. In some embodiments, the autonomous guidance system 1000 can be configured such that if the geolocation of the operator (as determined via the mobile device) is too close the geolocation of the autonomous vehicle, the vehicle can avoid the operator. In some embodiments, the autonomous guidance system 1000 can be configured such that the autonomous vehicle can be recalled to the operator using the geolocation of the operator (as determined via the mobile device).

In some embodiments, the mobile device can periodically (for example, every 15 minutes), show a notification to the operator to remind the operator to keep an eye on the autonomous vehicle. In some embodiments, if the operator does not respond to the notification by performing a certain action, such as pressing a button, then the autonomous vehicle can be configured to stop.

In some embodiments, a receiver on the vehicle constantly checks for periodic “run” commands from the mobile device. In some embodiments, the receiver can expect to receive commands at given time intervals (such as least once per second). In some embodiments, the receiver can be configured to check the message timestamp to ensure that it does not, or at least reduce the chance that is does, process old commands. In some embodiments, when the receiver does not receive run commands for more than a second, the receiver stops the vehicle.

In some embodiments, the receiver can contain multiple SIM cards from different internet service providers. In some embodiments, this offers failover redundancy which helps mitigate issues related to an outage of a single internet service provider.

In some embodiments, “run” and “stop” commands can be transmitted to several servers simultaneously. In some embodiments, these servers can be managed by third-party cloud service providers. In some embodiments, when one provider experiences an outage, the other provider will communicate the messages. In at least some embodiments, by sending the commands to multiple servers, the receiver can check whether one of the servers was illegitimately accessed i.e., hacked. For example, if one server is transmitting “run” commands and the other is transmitting “stop” commands, then the receiver will know that something is wrong and stop the vehicle.

In some embodiments, a Virtual Private Network (VPN) runs on the mobile device. In some embodiments, there is a strict protocol for granting the application access the servers (such as multi-factor authentication). In some embodiments, to connect to a vehicle, a user will need to turn on a physical switch on a vehicle. In some embodiments, pairing can be enabled for just a few seconds after the switch is turned on. In some embodiments, the receiver in the vehicle can generate a unique token (access code) which the application must transmit in future requests.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. An autonomous guidance system comprising:
(a) an autonomous vehicle, wherein said autonomous vehicle comprises:
(i) a GNSS antenna; and
(ii) an at least one SLAM component;
(b) a base station;
(c) an at least one satellite; and
(d) a server.

2. The autonomous guidance system of claim 1 wherein said autonomous vehicle is a lawnmower.

3. The autonomous guidance system of claim 1 wherein said autonomous vehicle is an agricultural tractor.

4. The autonomous guidance system of claim 1 wherein said autonomous vehicle is a land-survey device.

5. The autonomous guidance system of claim 1 wherein said at least one SLAM component is a camera.

6. The autonomous guidance system of claim 1 wherein said at least one SLAM component is a lidar.

7. The autonomous guidance system of claim 1 wherein said at least one SLAM component is an IMU.

8. The autonomous guidance system of claim 1 wherein said at least one SLAM component is a downward facing sensor.

9. The autonomous guidance system of claim 1 wherein said autonomous vehicle further includes a wheel encoder.

10. The autonomous guidance system of claim 1 in which the data from said at least one SLAM component is compared with RTK calculated data.

11. The autonomous guidance system of claim 1 wherein said GNSS antenna is used to generate a map.

12. The autonomous guidance system of claim 1 wherein said GNSS antenna is used to calibrate a model.

13. The autonomous guidance system of claim 11 wherein said map is shared with a second autonomous vehicle.

14. The autonomous guidance system of claim 13 wherein said model is shared with a second autonomous vehicle.

15. The autonomous guidance system of claim 1 further comprising:
(e) a mobile device.

16. The autonomous guidance system of claim 15 further comprising:
(f) a battery, wherein said battery is connected to said mobile device and acts as a stop switch.

17. The autonomous guidance system of claim 15 wherein said mobile device is used to control said autonomous vehicle.

18. The autonomous guidance system of claim 15 wherein said autonomous vehicle is configured to stop running when said mobile device is a given distance away.

19. The autonomous guidance system of claim 18 wherein said mobile device is a smartphone.

20. An autonomous guidance system comprising:
(a) a lawnmower, wherein said lawnmower comprises:
(i) a GNSS antenna;
(ii) an at least one camera;
(iii) a downward facing senor; and
(iv) a wheel encoder;
(b) a base station;
(c) an at least one satellite;
(d) a server; and
(e) a mobile device.
